(19) United States
(12) Patent Application Publication
(10) Pub. No.: US 2004/0098534 A1
(43) Pub. Date: May 20, 2004

(54) Memory data managing method and allocation thereof

(75) Inventors: Wei-Sheng Yin, Hsin-Chu City (TW); Ti-Wen Yuan, Hsin-Chu City (TW)

Correspondence Address: TROXELL LAW OFFICE PLLC, SUITE 1404, 5205 LEESBURG PIKE, FALLS CHURCH, VA, 22041, US

(73) Assignee: MediaTek Inc.

(21) Appl. No.: 10/704,619

(22) Filed: Nov. 12, 2003

(30) Foreign Application Priority Data
Nov. 13, 2002 (TW) 091133305

(51) Int. Cl. G06F 12/00

(52) U.S. Cl. 711/103; 711/154

(57) ABSTRACT

This invention provides a method for managing digital data and the digital data allocation in a memory, which is applied to a digital recording device. The memory can repetitively write and crase and comprises a plurality of sectors in which a plurality of digital data files can be written. The least unit to crase the digital data in the memory every time is one sector. Each sector divides to a plurality of blocks, and each block is arranged a block header. The block header can record the current status of the corresponding block. The method comprises a step to set up a block reclamation starting condition. When some blocks in a target sector have to be erased, the digital data of the other blocks which need not to be erased will be moved and stored in the blocks of other sectors.

### BACKGROUND OF THE INVENTION

1. Entry of the Invention

The present invention relates to a memory data managing method and the data allocation thereof, and particularly to a data managing method for a non-volatile memory of a digital recording device.

2. Description of the Prior Art

Now there are many digital recording devices, such as mobile phones with recording function, recording pens and the like. Most memories used in these devices are non-volatile memories, especially flash memories. Each flash memory divides into a plurality of sectors in advance. According to different manufacturers, the capacity of each sector ranges from 64 K bytes to 128 K bytes.

There are many kinds of methods for managing the digital data in a memory. For example, in the U.S. Pat. No. 5,943,692, each crase unit has a unit header, and each unit is divided to a plurality of blocks with different sizes. The size of one block changes according to the difference between the digital data of each file. However, the disadvantage of this method is the necessity to know the length of each file in advance to determine the size of one block. Besides, because each file occupies one block, and the size of each block cannot exceed one sector, the data length is limited by the sector.

However, these recording devices usually record real-time multimedia digital data, such as the audio message of a mobile phone, communication recordings, or video recordings. This kind of digital data are always with a large amount and not allowed to predict the length, so they are difficult to be stored iii one sector. Therefore the U.S. Pat. No. 5,943,692 cannot be used in recording these types of digital data.

Besides, in the recording device of prior art, when the memory space runs out and needs to delete some digital data, it cannot selectively delete only a part of digital data and reserve other important data, but can only delete all of the stored data at once.

In another prior art, a sector is the least storing unit. The prior art respectively stores the digital data in several sectors. The sector is also the least erasing unit. Therefore the digital data existing in different sectors can be erased separately. When the memory space runs out, digital data which are less important ca be deleted, while important digital data can be reserved.

However, the capacity of a non-volatile memory is at most hundreds of megabytes. But the size of the real-time multimedia digital data are usually very large the space of the memory must use efficiently. The prior art wastes a lot of memory spaces, thus brings some problems. Therefore, the present invention is designed to provide an efficient data managing method for a non-volatile memory to solve above problem.

### SUMMARY OF TITLE INVENTION

Accordingly, an objective of the present invention is to provide all efficiently memory data managing method and the data allocation thereof.

Using a preferred embodiment to explain, the memory allows repetitively writing and erasing, comprising a plurality of sectors for writing digital data of a plurality of digital files. The least erasing unit to erase the digital data in the memory is the sector. The method for managing the digital data in a memory first divides the sectors into a plurality of blocks. Each block has a block header for recording the current status of corresponding blocks. When the digital data recorded in at least one block of a target sector needs to be erased and to release the memory space of the block, the digital data in the other blocks, which need not to be erased, will be moved to the other blocks in the other sectors.

The present invention provides an efficient memory data managing method and the data allocation thereof. When the digital data in some blocks in a target sector needs to be erased, the present invention enables the digital data in other blocks in the target sector can be moved and stored in the blocks of other sectors, by dividing the sector into a plurality of blocks. Thereby we can efficiently managing the real-time multimedia digital data recorded by the digital recording device. The space of flash memory can be used efficiently, and the files can be deleted one by one. Besides, by the header, the present invention can reach the function of power loss recovery, thus the digital recording device will not lose digital data if the power failure occurs.

The advantage and spirit of the invention may be understood by the following recitations together with the appended drawings.

### BRIEF DESCRIPTION OF THE APPENDED DRAWINGS

FIG. 1 is a schematic diagram for the digital data allocation of a memory of the present invention.

FIG. 2 is a schematic diagram of a digital recording device applying the memory according to the present invention.

FIG. 3 is a flowchart of the memory data managing method of the present invention.

FIG. 4 is a schematic diagram indicating how the digital recording device in FIG. 2 arranges the blank blocks after the digital data managing method in FIG. 3 finished.

FIG. 5 is a schematic diagram of the memory data allocation diagram for the preferred embodiment according to the present invention.

FIG. 6 is a flow chart of the change of the block status entry in FIG. 1

FIG. 7A to FIG. 7E are the schematic diagrams of the block status of the memory in FIG. 5 during the block reclamation process.

### DETAILED DESCRIPTION OF THE INVENTION

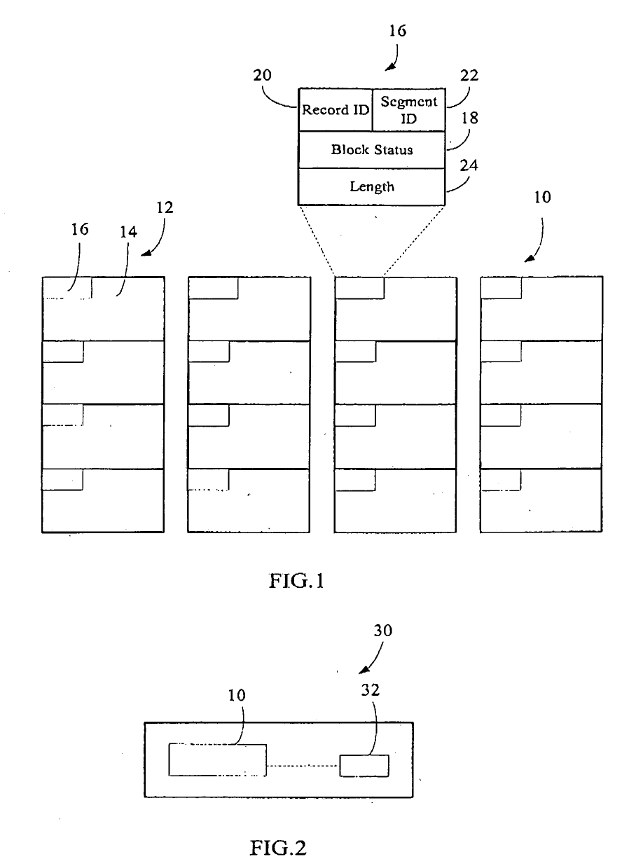

Please refer to FIG. 1. FIG. 1 is a schematic diagram for the digital data allocation of a memory 10 of the present invention. In the present invention, the memory 10 allows repetitively writing and erasing, and comprises a plurality of sectors 12 to write digital data of a plurality of digital files. When erasing the digital data in the memory 10, the least erasing unit is the sector 12. The memory 10 is a non-volatile memory, such as a flash memory or an EEPROM. The digital data are real-time multimedia digital data.

Each sector 12 divides into a plurality of blocks 14. Each block 14 comprises a block header 16. The block header 16 records the current status of the corresponding blocks. The block header 16 comprises a block status entry 18, a record ID entry 20, and a segment ID entry 22. The block status entry 18 is used for marking the writing status as writing, deleting, or moving for each block 14. The record ID entry 20 and the segment ID entry 22 are used for recording the information of the digital file to which the digital data belong in each block. The block header 16 can further comprise a length entry 24, for recording length of the digital data recorded in the corresponding block.

Please refer to FIG. 2. FIG. 2 is a schematic diagram of a digital recording device 30 applying the memory 10 of the present invention. The memory 10 is applied in a digital recording device 30. The digital recording device 30 comprises a memory 10 and a temporary memory 32. The temporary memory 32 comprises a file table (not shown in FIG. 2) for recording the block information, which indicates how the digital file distributes in the blocks, after the digital files are written into the memory.

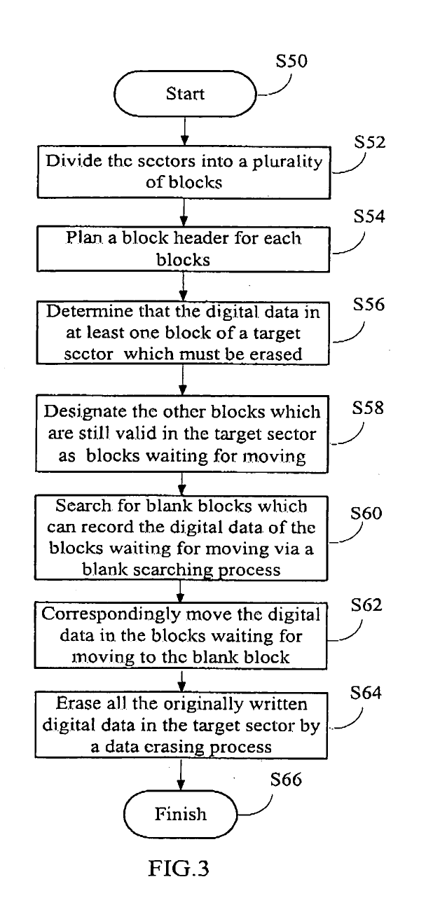

Please refer to FIG. 3. FIG. 3 is a flowchart of the memory data managing method of the present invention. The memory data managing method of the present invention comprises the following steps:

Step S50: Start;

Step S52: Divide the sectors 12 into a plurality of blocks 14;

Step S54: Plan a block header 16 for each blocks 14;

Step S56: Determine that the digital data in at least one block of a target sector which must be erased;

Step S58: Designate the other blocks which are still valid in the target sector as blocks waiting for moving to proceed with a block reclamation process;

Step S60: Search for blank blocks which can record the digital data of the blocks waiting for moving via a blank searching process;

Step S62: Correspondingly move the digital data in the confirmed blocks waiting for moving to the blank block searched by the blank searching process; and

Step S64: Erase all the originally written digital data in the target sector by a data erasing process;

Step S66: Finished.

According to an embodiment of the present invention, the Step S52 divides the sector 12 into the blocks 14 with the same size, in order that in the Step S62, the digital data in the other blocks which need not to be erased can be completely moved to the blocks in the other sectors.

According to another embodiment of the present invention, the Step S52 divides the sector 12 into the blocks 14 with different sizes. Therefore, the digital data, in the other blocks which need not to be erased have to be moved to the same or larger blocks in other sectors to keep the digital data complete.

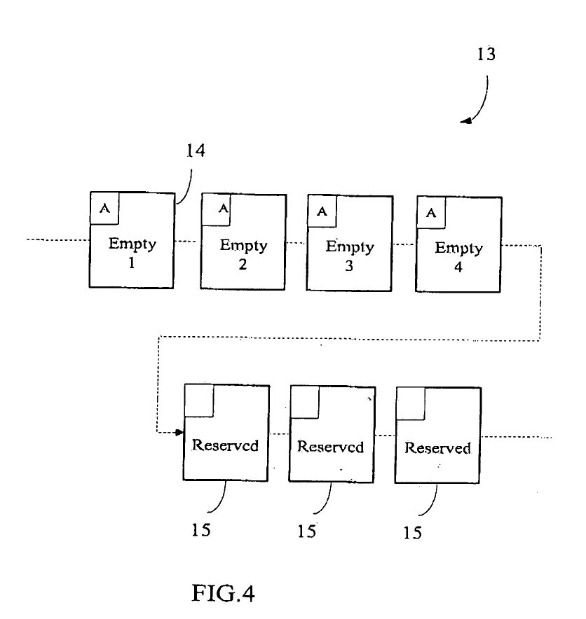

Please refer to FIG. 4. FIG. 4 is a schematic diagram of how the digital recording device 30 in FIG. 2 arranges the blank block after the data managing method in FIG. 3 finished. All the blocks erased by the data erasing process every time are linked by the digital recording device 30 according to erasing sequences and formed a blank block link 13. The last three blank blocks in the blank block link 13 are reserved as reserved blocks 15. The reserved blocks 15 are for backup when moving blocks. In Step S62, the blank block searching process obtains information of the required blank block from the blank block link 13, in order to continuously write the digital data of the blocks waiting for moving into the blank block.

If each sector 12 divides into M blocks with the same size, the memory 10 totally reserves (M−1) blocks as reserved blocks 15 for backup when moving blocks. For a conventional flash memory, because one sector has a capacity of 64 Kbytes (actually 2¹⁶ bytes) or 128 Kbytes (actually 2¹⁷ bytes), M needs to be 2ⁿ (n is natural number) to equally divide the sector. In the embodiment of FIG. 1, each sector 12 divides to four blocks with the same size, so the whole memory 10 totally reserves three blocks for reserved blocks 15.

According to another embodiment, the digital recording device 30 predetermines a block reclamation start condition. If the number of the blank blocks 14 in the memory 10 decreases to a predetermined amount, the block reclamation start condition will be conformed. The block reclamation start condition means that because the capacity of the memory 10 is not enough, the digital data of at least one block in the target sector must be erased to release the memory space of the block. For example, if the block reclamation start condition which is predetermined by the digital recording device 30 is that when the number of the blank blocks 14 in the memory 10 decreases to 20% of all blocks, the block reclamation must be proceeded. Before the block reclamation start condition is conformed, even if the user asks to delete digital data, the digital recording device 30 will only change the segment ID entry 22. The digital data in the memory 10 need not to be moved. Until the block reclamation start condition is conformed, the digital recording device 30 starts the block reclamation process.

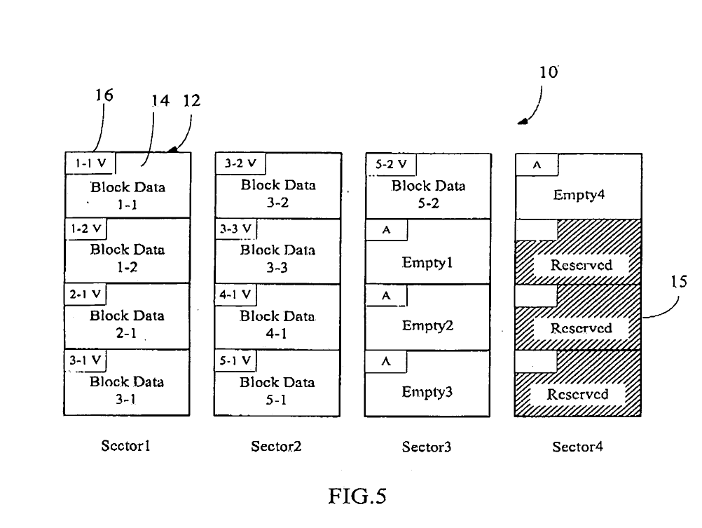

Please refer to FIG. 5. FIG. 5 is a schematic diagram of the memory data allocation for an embodiment of the present invention. The memory 10 records five digital files in a plurality of blocks 14 with the same size. Each block header 16 respectively records the current status of the corresponding block. Take the block 1-1 for example. The block 1-1 records the first segment of the first file, so the block header 16 shows 1-1V, which means both the record ID entry 20 and the segment ID entry 22 of the block 1-1 are 1, and the block status entry 18 is valid (V).

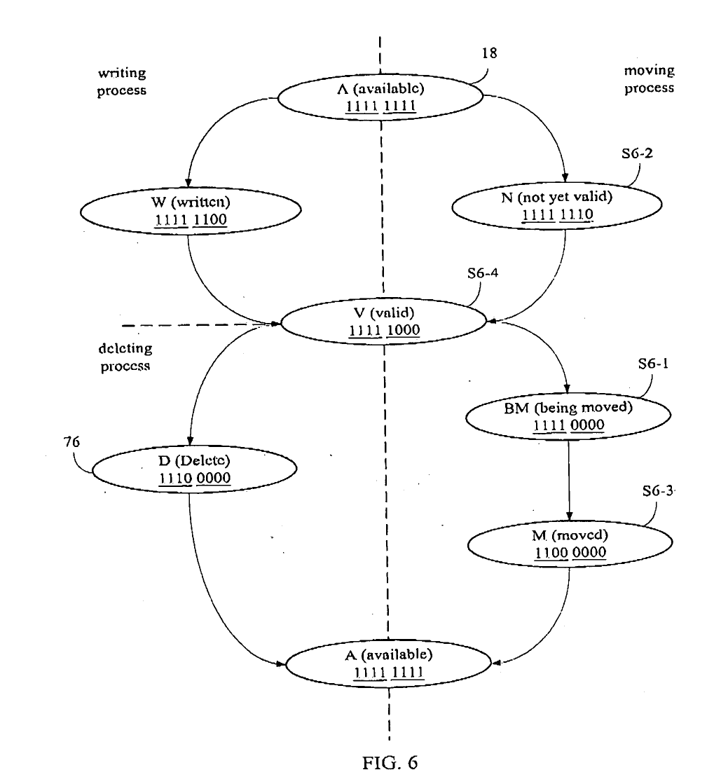

Referring to FIG. 6, FIG. 6 is a schematic diagram for showing the change of the block status entry 18 in FIG. 1 represents the change of the block status. The block status entry 18 marks the status as writing, deleting or moving for each block. When power failure occurs, each block 14 can proceed with a corresponding power loss recovery, according to the marked status of the block status entry to make sure the correctness and integrity of the digital data in the memory.

In FIG. 6, the upper-left is the changing process of the block status entry 18 when writing; the lower-left is the changing process of the block status entry 18 when deleting; the right is the changing process of the block status entry 18 when moving. When the block 14 is a blank block can record digital data, the block status entry 18 is A (available), digitally represented by 8 bits as 1111 1111. In writing process, after preparing the digital data for writing, first change the block status entry 18 to W, digitally represented as 1111 1100, which means the block is written. Then start writing. When writing is finished, change the block status entry 18 to V (valid), digitally represented as 1111 1000, which means the block 14 has recorded digital data. When going to delete the digital data in the block 14, which has already recorded digital data, change the block status entry 18 from V to D (Delete), digitally represented as 1110 0000, which means the block 14 can be deleted.

If the power failure occurs when writing, after the power recovers, the digital recording device 30 can check the block status entry 18 of the block 14. If the block status entry 18 is W, which means the block 14 was writing when power failure, the digital data in the block 14 will be deleted because of incompleteness. If the block status entry 18 is V, which means the block 14 has finished writing when power failure, thus the digital data in the block 14 would not affect by power failure.

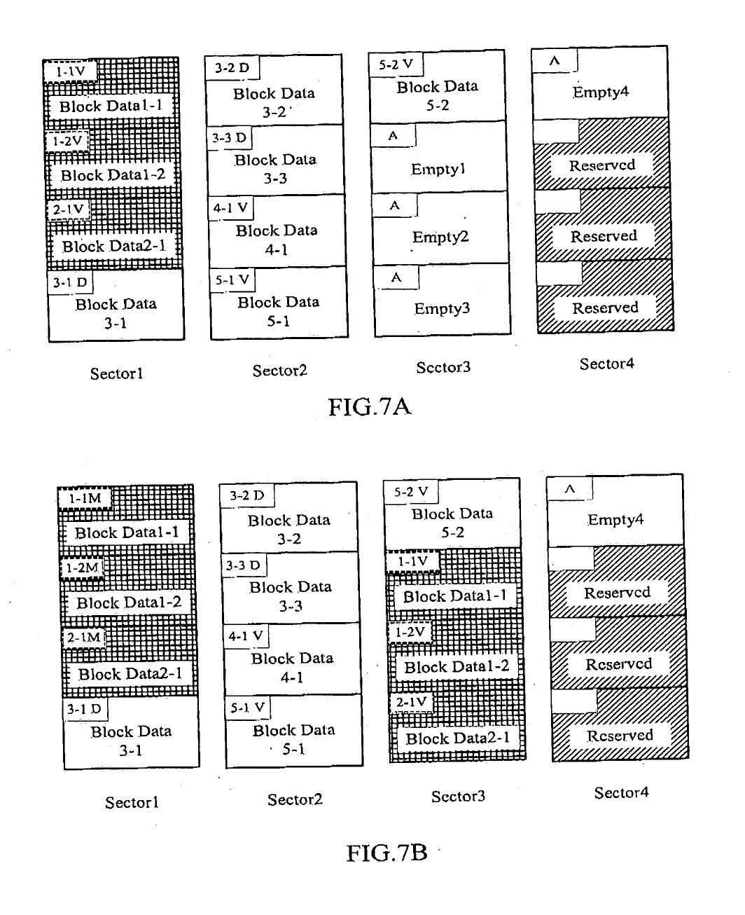

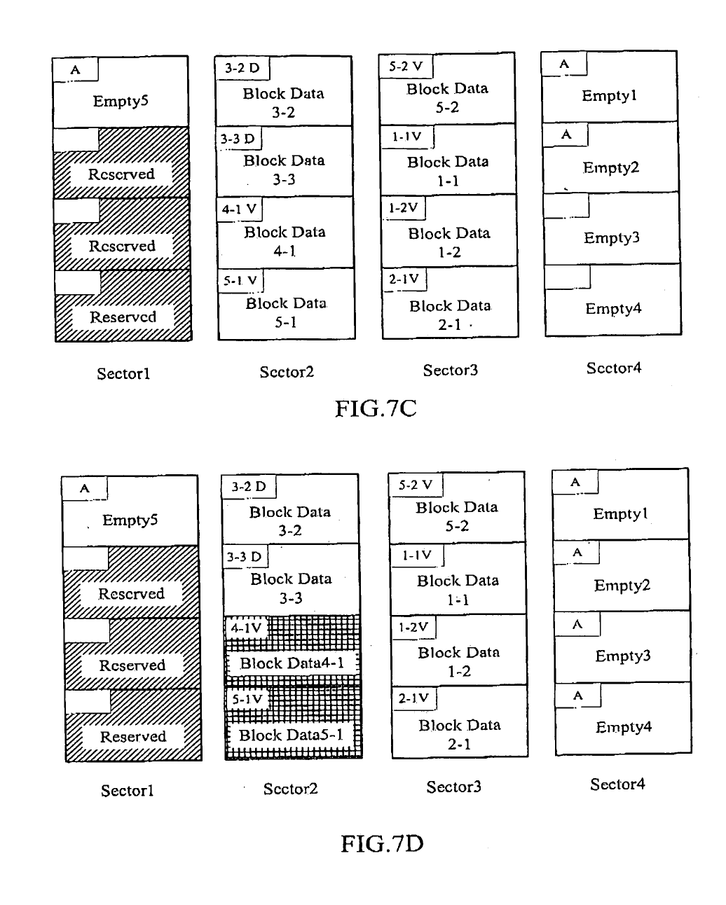

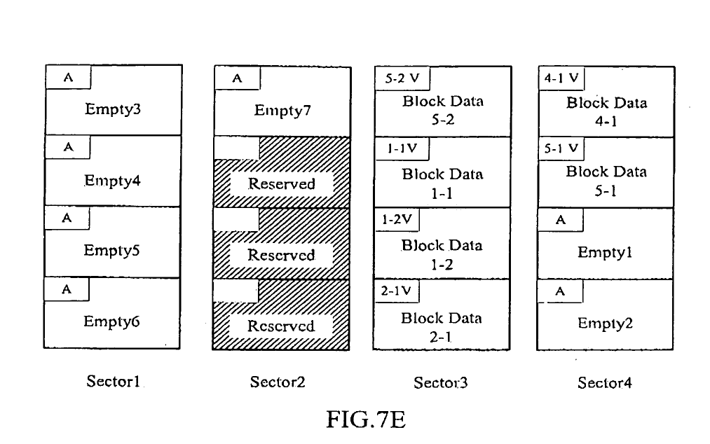

Please refer to FIG. 7A to FIG. 7E. FIG. 7A to FIG. 7E are the schematic diagrams of the block status of the memory in FIG. 5 during the block reclamation process. When the digital recording device 30 conforms to the block reclamation start condition the digital data of at least one block in the target sector must be erased to release the memory space of the block. The block reclamation process comprises moving the valid blocks and erasing the sector. Take the embodiment of FIG. 5 for example. If a user directs to delete the third file, the block 3-1, block 3-2, block 3-3 respectively allocated in sector 1 and sector 2 are marked as D. Now the target sectors are the sector 1 and sector 2. Conventionally, the least erasing unit of a flash memory is a sector. Thus, in order to avoid erasing the digital data which are still desired, it is necessary to move the block 1-1, block 1-2, block 2-1 in sector 1 and the block 4-1, block 5-1 in sector 2, all of them with a block status entry 18 V (shown in FIG. 7A). These digital data in the blocks will be moved to other blocks 14.

Now explain the process for moving the sector 1. The digital recording device 30 proceed withs the blank searching process, using the blank block links 13 in FIG. 4 to find the blank block for writing. By the blank searching process find that there are still three blank blocks for writing in the sector 3. Move the digital data in the block 1-1, block 1-2, and block 2-1 correspondingly to the blank block 1, blank block 2, and blank block 3.

Please also refer to FIG. 6. Here explain the process of moving the digital data from block 1-1 to the blank block 1 in FIG. 7A with reference to FIG. 6. The steps of the process are as below.

Step S6-1: Change the block status entry 18 of the block 1-1 from V to BM (being moved), digitally represented as 1111 0000, which means the block 1-1 is being moved; before completing moving, the block status entry 18 of the block 1-1 keeps BM;

Step S6-2: Change the block status entry 18 of the blank block 1 from A to N (not yet valid), digitally represented as 1111 1110, and change both the record ID entry 20 and the segment ID entry 22 of tide blank block 1 to 1, that means the blank block 1 is receiving the digital data from the block 1-1; before completing moving, the block status entry 18 of the blank block 1 keeps N;

Step S6-3: Start moving digital data; after completing moving, change the block status entry 18 of the block 1-1 from. BM to M (moved), digitally represented as 1100 0000, that means the digital data in the block 1-1 has already been moved to the blank block 1;

Step S6-4: After completing moving, change the block status entry 18 of the blank block 1 from N to V; now the blank block 1 has become another complete block 1-1.

In the process of moving, whenever the power failure occurs, the digital recording device 30 can always continue the process after the power recovers by checking the block status entry 18 of each block. In this way, the digital data in the memory will not lose because of the power failure. Here is an example. The power failure occurs during step 6-2, when the blank block 1 is receiving the digital data from the block 1-1. Firstly, the digital recording device 30 will check the block status entry 18 of the block 1-1 and the blank block 1 after the power recovers. Then the digital recording device 30 finds that the status of block 1-1 is BM, the status of the blank block 1 status is N, and both the record ED entry 20 and the segment ID entry 22 of the blank block 1 are 1. According to the block status entries 18, this means that before the power failure, the blank block 1 is receiving the digital data from the block 1-1 but not yet finished. Thus the digital, recording device 30 will move the digital data again from the block 1-1 to the blank block 1.

Here is another example. In this time, the power failure occurs during step 6-3, when the digital data, in the block 1-1 has been moved. Similarly, the digital recording device 30 firstly checks the block status entry 18 of the block 1-1 and the blank block 1 after the power recovers. Then it finds that the of block 1-1 is M and the status of the blank block 1 is N, and both the record ID entry 20 and the segment ID entry 22 of the blank block 1 are 1. According to the block status entries 18, this means that before the power failure, the digital data in the block 1-1 has been moved, but the blank block 1 does not change the block status entry 18 yet. Thus the digital recording device 30 just needs to change the block status entry 18 of the blank block 1 to V. In this way, the digital recording device 30 will not lose any digital data because of the power failure when moving.

FIG. 7A, after finishing moving the digital data from the block 1-1 to the blank block 1, repeat the Steps 6-1 to 6-4 to the block 1-2 and block 2-1. FIG. 713 is a schematic diagram of the block status after the sector 1 in FIG. 7A finishing the digital data moving process. In FIG. 7B, the block 1-1, block 1-2, and block 2-1 in the sector 1 have all moved to the blank block 1, blank block 2, and blank block 3 in the sector 3, so the block status entries 18 of the block 1-1, block 1-2, and block 2-1 are all shown as M. The blank block 1, blank block 2, blank block 3 in the sector 3 all become the new block 1-1, block 1-2, and block 2-1. Now, the digital recording device 30 has erases all the digital data in the sector 1 (the target sector) via a data erasing process. Conventionally the data erasing process of the non-volatile memory is to erase all the digital data in, the target sector to the bit 1, for writing the digital data into the target sector later.

Please refer to FIG. 7C. FIG. 7C is a schematic diagram of the block status for the blocks in FIG. 7B after erasing the sector 1. Because the digital data in the block 1-1, block 1-2, and block 2-1 in the sector 1 have moved to the sector 3, all the blocks 14 in the sector 1 become the blank blocks again. The digital recording device 30 continuously links the blocks of the sector 1 after the blank block links 13 in FIG. 4. Because the sequences to erase the digital data are different, the last three blocks in the sector 1 become the last three blocks of the blank block links 13. Therefore the last three blocks are reserved as the reserved blocks.

Then proceed with the process of moving the block 4-1 and block 5-1 in the sector 2. Please refer to FIG. 7D. FIG. 7D is a schematic diagram of the block status of the blocks in the sector 2 before moving. After finishing the blank searching process, the digital recording device 30 finds that there are blank blocks for writing in the sector 4. Then the digital recording device 30 repeats steps S6-1 to S6-4, moving the digital data in the block 4-1 and block 5-1 to the blank block 1 and blank block 2, then erases the digital data in the sector 2.

Please refer to FIG. 7E. FIG. 7E is a schematic diagram of the block status of the blocks after finishing the block reclamation process. Compare FIG. 5 with FIG. 7E, the digital data in the sector 1, and sector 2 are all erased. The digital data in the block 3-1, block 3-2, block 3-3 which belong to the third digital file are all erased and release their memory space. All of the block 1-1, block 1-2, block 2-4, block 4-1., and block 5-1 in the sector 1 and sector 2 are respectively moved to the sector 3 and sector 4.

After finishing the digital data managing method in FIG. 3, the digital recording device 30 renews the file table in the temporary memory 32 to record the information of how the digital filches allocated in the memory 10. Therefore, the digital recording device 30 can correctly access the first, second, third, forth, and fifth files without any problems caused by the digital data moving.

According to the present invention, the method for managing digital data in a memory and the data allocation thereof. The method uses a plurality of blocks. When the digital data in some blocks in a target sector need to be erased, the blocks enable the digital data in the other blocks of the target sector to be moved and stored in the blocks of the other sector. Thereby, the present invention efficiently manages the real-time multimedia digital data recorded by the digital recording device and uses the space of a flash memory. The present invention achieves the function to delete digital files one by one. Moreover, by the header, the present invention achieves the power failure recovery and the digital recording device will not lose digital data if the power failure occurs.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method applied in a digital recording device for managing digital data in a memory, the memory allowing repetitively writing and erasing, which comprises a plurality of sectors for writing digital data of a plurality of digital files, the least erasing unit to erase the digital data in the memory is the sector, the method comprising the following step:
dividing the sectors into a plurality of blocks, each block having a block header for recording the current status of the corresponding block;
wherein, when the digital data recorded in at least one block of a target sector which needs to be erased and to release the memory space of the block, digital data in the other blocks which need not to be erased will be moved to the other blocks in the other sectors.

2. The method for managing digital data in a memory of claim 1, wherein the blocks are with the same size, in order that the digital data which need not to be erased in the other blocks are able be completely moved to the blocks in the other sectors.

3. The method for managing digital data in a memory of claim 1, wherein the blocks are not with the same size, therefore the digital, data which need not to be erased in the other blocks have to be moved to the same or larger blocks in other sectors to keep the digital data complete.

4. The method for managing digital data in a memory of claim 1, wherein the digital recording device comprises a temporary memory, the temporary memory comprising a file table for recording the block information indicating how the digital file distributes in the blocks, after the digital file is written in the memory.

5. The method for managing digital data in a memory of claim 4, further comprising a block reclamation process, which comprises the following steps:
confirming the blocks needing to be moved in the target sector, and searching for blank blocks able to record the digital data waiting for moving via a blank searching process;
correspondingly moving the digital data in the confirmed blocks to the blank block searched by the blank searching process; and
erasing all the originally written digital data in the target sector by a data erasing process.

6. The method for managing digital data in a memory of claim 5, wherein before the block reclamation process, set up a block reclamation start condition which means that the digital data of at least one block in the target sector must be erased to release the memory space of the block.

7. The method for managing digital data in a memory of claim 6, wherein before proceeding with the block reclamation process, the block reclamation start condition must be conformed first.

8. The method for managing digital data in a memory of claim 1, wherein the memory is a non-volatile memory.

9. The method for managing digital data in a memory of claim 8, wherein the non-volatile memory is a flash memory.

10. The method for managing digital data in a memory of claim 9, wherein the data erasing process is to crase the originally written digital data in, the target sector of the flash memory to the bit “1” for writing the digital data again later.

11. The method for managing digital data in a memory of claim 1, wherein the block header comprises a block status entry, a record ID entry, a segment ID entry, and a length entry.

12. The method for managing digital data in a memory of claim 11, wherein the block status entry is used for marking the status as writing, deleting, or moving for each block in order that when power failure, each block can proceed with a corresponding power loss recovery according to the marked status as the block status entry to make sure the correctness and integrity of the digital data in the memory.

13. The method for managing digital data in a memory of claim 11, wherein the record ID entry and the segment ID entry is used for recording the information of the digital file to which the digital data belong in each block.

14. The method for managing digital data in a memory of claim 6, wherein if the blank blocks in the memory decrease to a predetermined amount, the block reclamation start condition will be conformed.

15. The method for managing digital data in a memory of claim 2, wherein each sector divides into M blocks with the same size, and the memory totally reserves (M−1) blocks as reserved blocks for backup when moving the blocks.

16. The method for managing digital data in a memory of claim. 5, wherein all the blocks erased by the data erasing process every time are linked according to erasing sequences and formed a blank block link, the blank block searching process obtaining the blank block to move in the digital data from the blank block link.

17. The method for managing digital data in a memory of claim 1, wherein the digital data are real-time multimedia digital data.

18. A memory being applied in a digital recording device, allowing repetitively writing and erasing for writing digital data of a plurality of digital files, the memory comprising a plurality of sectors for writing the digital data, where the digital data in the memory are erased, the sector acting as the least erasing unit, each sector further divided into a plurality of blocks; wherein, when the digital data recorded in at least one block of a target sector need to be erased, digital data in the other blocks which need not to be erased will be moved to the other blocks in the other sectors.

19. The memory of claim 18, wherein the blocks are with the same size, in order that the digital data which need not to be erased in the other blocks are able to be completely moved to the blocks in the other sectors.

20. The memory of claim 18, wherein the blocks are not with the same size, therefore the digital data which need not to be erased in the other blocks have to be moved to the same or larger blocks in other sectors to keep the digital data complete.
